(19) United States
(12) Patent Application Publication
(10) Pub. No.: US 2007/0229008 A1
(43) Pub. Date: Oct. 4, 2007

(54) Hand power tool

(76) Inventors: Heiko Roehm, Stuttgart (DE); Gyula Gondos, Miskolc (HU)

Correspondence Address: STRIKER, STRIKER & STENBY, 103 EAST NECK ROAD, HUNTINGTON, NY, 11743, US

(21) Appl. No.: 11/395,482

(22) Filed: Mar. 31, 2006

(51) Int. Cl. H02P 7/00

(52) U.S. Cl. 318/432

(57) ABSTRACT

A hand power tool includes a housing (10) with an upper part (11) for receiving at least an electric motor and a gear, with a middle part (12) embodied as a hand grip (14), and with a lower part (13) embodied as a base (16) to stand on, in which the middle part (12) receives at least one rechargeable battery.

### PRIOR ART

The invention relates to a hand power tool as generically defined by the preamble to claim 1.

For some years, cordless hand power tools with a power supply that is independent from the power grid for the electric motor have gained broad use, since the independence from the power grid has many advantages for manipulating such hand power tools.

From German Patent Disclosure DE 103 45 135 A, a cordless screwdriver with a pistol-like hand grip is already known, in which a rechargeable battery for supplying voltage is integrated into the hand grip of the cordless screwdriver housing. For charging the battery, the cordless screwdriver is placed in a charging shell, which can be set down, standing securely, on a flat surface. In the region of the lower end of the hand grip, charge contact tongues are provided, which in the charging mode rest on charging contacts of the charging shell, without separate cables or coupling plugs having to be actuated.

From German Patent Disclosure DE 102 12 750 A, a hand power tool, such as a power drill or drill/screwdriver, on whose housing a battery pack system can be mounted. For mechanically connecting the housing to the battery pack system, detent elements are provided on the one hand, while for the electrical connection contact elements are present on the other. The battery pack may for instance be mounted on the base of the hand grip of the hand power tool, and at least one side face of the battery pack is embodied as a face to stand on, so that the hand power tool equipped with the battery pack system can be set down on a flat surface.

The construction of the hand power tool known from DE 102 12 750 A is not sufficiently compact, since the components for generating and switching off torque on the one hand and the battery pack system on the other are located spatially separately from one another, one in the upper part of the housing and the other in the base of the hand grip.

### DISCLOSURE OF THE INVENTION

The hand power tool of the invention allows a more-compact construction as well as more convenient manipulation. This is attained by providing that the housing has an upper part, for receiving at least one electric motor and one gear, a middle part embodied as a hand grip, and a lower part embodied as a base to stand on; the middle part receives the at least one rechargeable battery.

In the hand power tool of the invention with a base to stand on, the rechargeable battery is preferably integrated with the housing in the region of the hand grip. This makes an overall compact construction possible with at the same time great stability of the hand power tool. In particular, the base to stand on can be made comparatively flat, since it need not receive any batteries. Thus the entire structural height of the hand power tool of the invention is also less than in a comparable hand power tool with a rechargeable battery integrated into the base or with a battery embodied as a base. The structural height of the hand power tool is understood to be the maximal distance between the underside of the base and the top side of the upper part.

For this purpose, lithium ion cells are advantageously used, since because they have no memory effect and do not discharge on their own, they make a high number of charging and discharging cycles possible, as well as a long service life, and thus need not be replaced and can instead be permanently built into the housing. Lithium ion cells also have the advantage that because of their greater energy density, the weight of the hand power tool is less in comparison to a hand power tool with a rechargeable battery based on a nickel-cadmium or nickel-metal hybrid cell. For instance, three series-connected, cylindrical lithium ion cells, each of 3.6 V, for instance, for a total voltage of 10.8 V, may be provided. To design the hand power tool even more compactly, instead of the cylindrical individual cells, a single lithium polymer cell may be used, preferably one adapted to the contour of the hand grip.

The middle part of the hand power tool, embodied as a hand grip, is embodied in particular as a pistol-like hand grip. The pistol-like hand grip is preferred for ergonomic reasons, because it is especially handy and has an especially advantageous force transmission in the axis of the hand power tool that is parallel to the working direction. Within the context of the present invention, the working direction is understood to mean the direction in which the hand power tool is guided during operation, such as for drilling and screwing. Moreover, in the case of a pistol-like hand grip, disposing the ON-OFF switch in the form of a trigger is especially advantageous.

The lower part, embodied as a base to stand on, in particular has an underside that can be set down on a substantially flat surface. The underside is embodied such that it can be set down at least in part on a substantially flat surface. The underside may also be designed such that it can be set down, in particular over its full surface area, on a substantially flat surface. The hand power tool of the invention can be set down on the underside of the base to stand on without further bracing, for instance in a holding or carrying element.

In a preferred embodiment, the base to stand on is embodied such that for charging the at least one rechargeable battery, the base can be set down in a charging device (hereinafter also called a charging station). Thus in addition to the charging function, the charging device has a parking function, that is, the function of a stand. The charging device is embodied such that the base to stand on can be set down in the charging device. To that end, the charging device has a recess for receiving the base to stand on. The recess is designed in particular such that the base to stand on engages the recess in form-locking fashion. Hence the depth of the recess, for instance, is essentially equivalent to the height of the base to stand on. Increased stability of the base, standing in the recess of the charging device, can be achieved by means of an additional force-locking connection, in particular a snap connection, between the base and the recess. For that purpose, the base and the recess are provided with snap elements that engage on one another. This makes a stable but easily undone connection of the base with the recess possible. Moreover, contact elements for electrically connecting the base to the charging device are provided on the base. The detent elements and/or contact elements are preferably located on the underside of the base. In addition or alternatively, they may also be provided on one or more side faces. The contact elements of the charging device protrude out of the charging device in a suitable region of the recesses, so that the contact elements of the charging device contact the contact elements of the base.

The charging device may additionally have recesses for storing replaceable tool inserts. These recesses are preferably provided on the top side of the charging device but may also be located laterally in the charging device.

Means for electronic torque limitation are preferably provided In the base. An electronic torque limiter in particular makes a smaller structural length of the hand power tool possible, compared to a hand power tool with mechanical torque coupling. Within the context of the present invention, the structural length of a hand power tool is understood to mean the length of its upper part. For targeted triggering of the torque limitation, at least one printed circuit board with the appropriate components is provided in the base. An electronic torque limiter or torque shutoff is known in the prior art. In it, the current-controlling principle of a shutoff screwdriver can for instance be employed. In preliminary tests, a shutoff value for the torque has been ascertained that is adjusted at a potentiometer. In operation of the hand power tool, the current intensity, which increases in proportion to the torque of the motor, is compared, for instance via a digital controller, with the current intensity that increases at the potentiometer. When the set-point value is reached, a shutoff pulse is tripped, which stops the electric motor. The fact that the maximum torque has been reached and the torque has been shut off can be imparted to the user by means of an acoustical signal, such as a chirping tone. The risk of a thermal overload can also be displayed by means of a further acoustical signal, such as three successive chirping tones.

To adjust the torque, the means for electronic torque limitation have a control knob, preferably in the base, and especially preferably on the top side of the base. The desired torque can be adjusted using a scale on the circumference of the control knob.

In a further embodiment of the hand power tool of the invention, the base has at least one radiation source. The radiation source is preferably a light-emitting diode (LED). The radiation source, especially the light-emitting diode, is located in an outer region of the lower part embodied as a base to stand on. The radiation source is preferably located in the region of the free end of the base, since then the radiation source will not be covered by the user's hand. The free end of the base is understood to be the end that is facing away from the middle part of the housing that is embodied as a hand grip. The radiation source is also preferably located on the top side of the base and is oriented such that the work area is illuminated. Within the context of the present invention, the work area of a hand power tool is understood to be the area which includes at least the free end of the tool insert, such as a drill bit or screwdriver bit, that is fastened in the upper part.

The radiation source, in particular the light-emitting diode, is preferably covered by a substantially transparent covering disk which has convex curvature, so that the cover disk acts as a focusing lens and focuses the beam of light, emitted by the light-emitting diode, onto the work area of the hand power tool.

In a further embodiment, the base has at least one viewing area for displaying the charge status of the battery. The charge status is displayed in particular by means of a light-emitting diode. A plurality of viewing areas may also be provided, each displaying a different charge status of the battery. A plurality of viewing areas may be located arbitrarily relative to one another. For instance, three viewing areas may be located side by side, with each viewing area displaying a certain proportion of the charge capacity, such as 100%, 60%, and 30%. If there are a plurality of viewing areas for displaying different charge statuses, then one light-emitting diode, each of a different color, may be provided for each charge status. Preferably, the at least one viewing area is located on the top side of the base. This makes the viewing area readily visible to the user.

In a preferred embodiment, the base, and in particular the top side of the base, holds at least one radiation source, one viewing area for displaying the charge status of the battery, and one device for adjusting the torque.

The top part of the hand power tool of the invention holds at least one electric motor, such as a conventional direct current motor, and one gear, such as a multi-stage planetary gear. Via the gear, the electric motor drives a work spindle, which has a chuck. The chuck may be a fast-action chuck, which is usual for power drills, for instance, or an insertable chuck or a magnetic chuck.

The upper part, middle part and lower part of the housing of the hand power tool are embodied in particular in one piece. The housing shape comprising the upper part, middle part and lower part, makes an advantageous distribution of the components over the entire housing possible, thus attaining a compact construction. The housing is preferably embodied as two shells, with one housing shell holding the components, such as the electric motor, gear, rechargeable battery, and printed circuit board.

The hand power tool of the invention in particular a battery-operated hand power tool, such as a cordless power drill, or a cordless screwdriver.

A further subject of the invention is a device for charging the hand power tool of the invention, which in the context of the present invention is also called a charging device. The charging device has a recess for receiving the lower part of the hand power tool, embodied as a base to stand on. The base engages the recess in form-locking and/or force-locking fashion. For a force-locking engagement, detent or snap elements are provided on the base and in the recess, for instance on the underside of the base. In addition, contact elements, which can be contactable to one another, are provided in the recess and on the base, for instance on the underside, so that for charging the battery in the hand power tool, an electrically conductive connection can be made between the base of the hand power tool and the charging device.

The invention is described in further detail below in conjunction with the accompanying drawings.

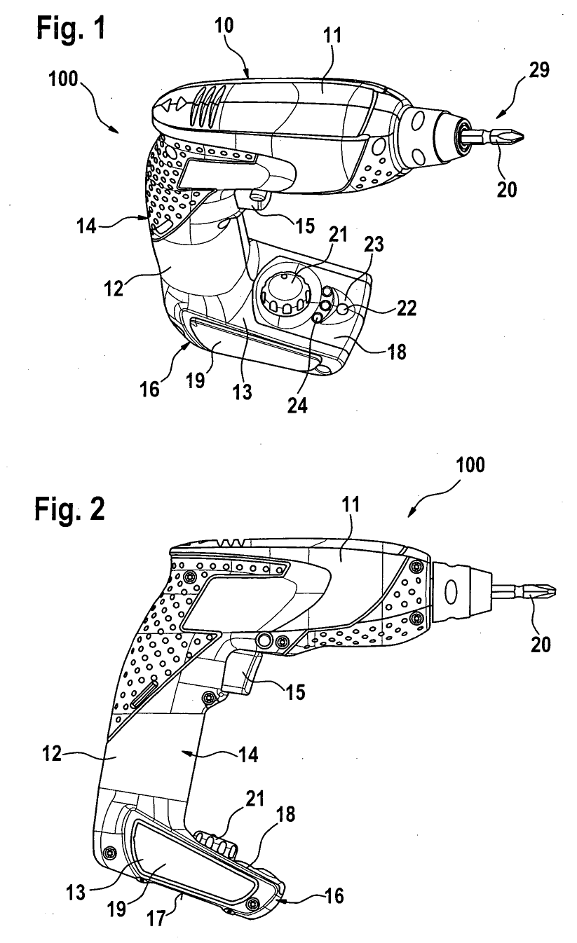

FIG. 1 shows one embodiment of the hand power tool of the invention in perspective;

FIG. 2 shows the hand power tool of FIG. 1 in a side view;

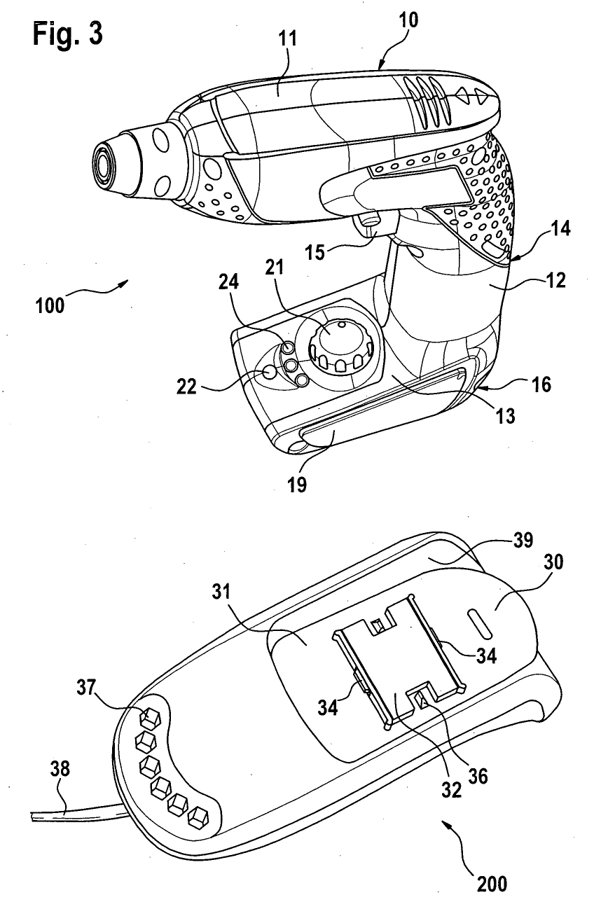

FIG. 3 shows the hand power tool of FIG. 1 and an embodiment of a device according to the invention for charging the hand power tool, in perspective;

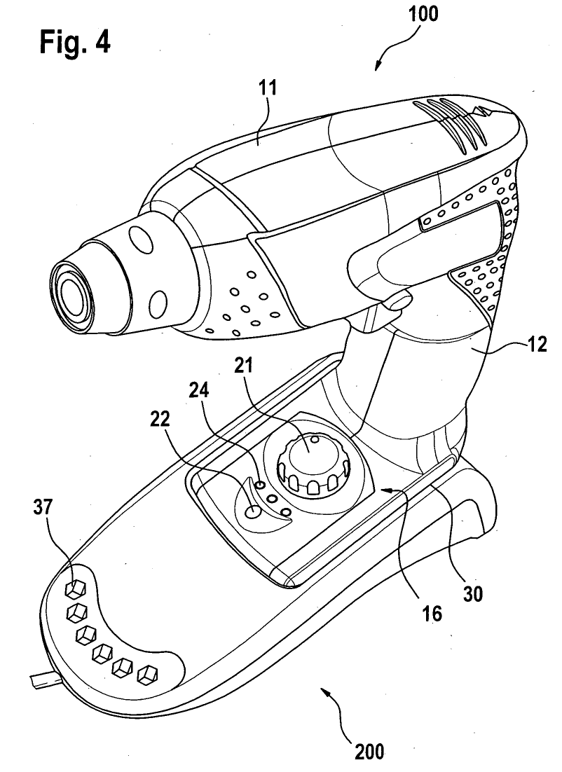

FIG. 4 shows the hand power tool of FIG. 1 in the charging device of FIG. 3;

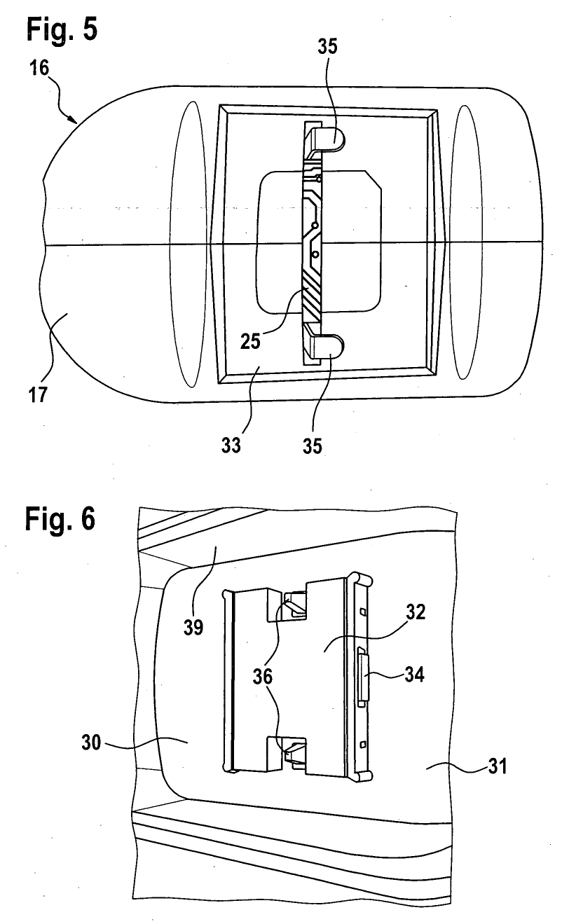

FIG. 5 shows the underside of the base of the hand power tool of FIG. 1 in plan view;

FIG. 6 shows a detail of the recess of the charging device of FIG. 3 in perspective.

In FIG. 1, a preferred embodiment of a cordless screwdriver 100 is shown. The housing 10 comprises an upper part 11, a middle part 12, and a lower part 13. The middle part 12 is embodied in the form of a pistol-like hand grip 14; that is, the upper part 11 and the middle part 12 are located in it at an angle to one another, in a way similar to a pistol. In the upper region of the hand grip 14, below the upper part 11, an ON/OFF switch 15 in the form of a trigger is provided. It is actuated with the index finger, in a way similar to a pistol. The middle part 12 embodied as a hand grip 14 receives at least one rechargeable battery (not shown). The lower part 13 is embodied as a base 16 to stand on. The base 16 has a substantially flat underside 17, on which the base 16 can be set down on a substantially flat face. The lower part 13 is likewise located at an angle to the middle part 12. The upper part 11, middle part 12, and lower part 13 are in one piece, and the angled disposition of the upper part 11, middle part 12 and lower part 13 means that the housing 10 is C-shaped.

In the base 16, means for electronic torque limitation are provided, which include at least one printed circuit board 25 (see FIG. 5), a potentiometer, and a control knob 21 for adjusting the torque, using a scale (not shown) located on the circumference of the control knob 21 on the top side 18 of the base 16.

The base 16, on its top side 18, also has at least one radiation source 22, in the form of a light-emitting diode (LED). The radiation source is located and oriented such that the work area 29 is illuminated. The work area 29 is understood to mean that region which includes at least the free end of the tool insert 20, in this case a screwdriver bit, that is fastened in the upper part 11.

The radiation source 22 in the form of a light-emitting diode is preferably covered by a substantially transparent cover disk 23, which is convex in curvature, so that the cover disk 23 serves as a focusing lens and focuses the beam of light, emitting by the light-emitting diode, onto the work area 29 of the cordless drill 100.

The base 16, on its top side 18, moreover has at least one viewing area 24 for displaying the charge status of the battery. The charge status is displayed in particular by means of a light-emitting diode. In the embodiment shown in FIG. 1, three viewing areas 24 are provided, which each display a different charge status of the battery, such as 100%, 60%, and 30% of the charge capacity. The three viewing areas 24 are formed by three different light-emitting diodes, with three different colors, such as green, yellow, and red.

The base 16 is furthermore embodied such that for charging the at least one battery, the base 16 can be set down in a charging device 200. Thus the charging device 200 has not only the charging function but also a parking function, or the function of acting as a stand. The charging device 200 has a recess 30 for receiving the base 16. The recess 30 is designed in particular such that the base 16 engages the recess 30 in form- and force-locking fashion (see FIG. 4). To that end, the inside face 31 of the recess 30 has a protrusion 32. The protrusion 32 engages a recess 33 on the underside 17 of the base 16. In addition, the protrusion 32 is provided with snap elements 34, in the form of spring-loaded locking bars.

On the underside 17 of the base 16, contact elements 35 for electrically connecting the base 16 to the charging device 200 are also provided in the recess 33. The contact elements 36 of the charging device 200 protrude, in a suitable region of the inside face 31 of the recess 30, out of the charging device 200, so that the contact elements 36 of the charging device 200 contact the contact elements 35 of the base 16. The charging device 200 is connected to an electrical power supply via a cord 38. It can be set down on a substantially flat surface.

The charging device 200 furthermore has recesses 37 for storing interchangeable tool inserts 20.

FIG. 4 shows the cordless screwdriver in the charging device 200. It can be seen here that the shape of the recess 30 is adapted to the shape of the base 16, so that the base 16 engages the recess 30. The side faces 19 of the base 16 are surrounded by the side faces 39 of the recess 30. The underside 17 of the base 16 rests at least partly on the inside face 31 of the recess 30.

1. A hand power tool, including a housing (10) with an upper part (11) for receiving at least an electric motor and a gear, with a middle part (12) embodied as a hand grip (14) and receiving at least one rechargeable battery, and with a lower part (13) embodied as a base (16) to stand on, wherein the rechargeable battery is integrated entirely with the housing of the hand grip and is neither integrated into the base nor embodied as the base.

2. The hand power tool as defined by claim 1, wherein the middle part (12) is embodied as a pistol-like hand grip (14).

3. The hand power tool as defined by claim 1, wherein means (25) for electronic torque limitation are provided in the lower part (13).

4. The hand power tool as defined by claim 3, wherein the means (25) for electronic torque limitation include a control knob (21) for adjusting the torque.

5. The hand power tool as defined by claim 1, wherein the lower part (13) has at least one radiation source (22).

6. The hand power tool as defined by claim 5, wherein the radiation source (22) is oriented such that the work area (29) of the hand power tool is illuminated.

7. The hand power tool as defined by claim 1, wherein the lower part (13) has at least one viewing area (24) for displaying the charge status of the battery.

8. The hand power tool as defined by claim 7, wherein a plurality of viewing areas (24) are provided, which each display a different charge status of the battery.

9. A device for charging a hand power tool as defined by claim 1, with a receptacle (30) for receiving at least part of the hand power tool, the recess (30) having contact elements (36) which are contactable with contact elements (35) of the hand power tool, wherein the receptacle (30) is embodied such that the lower part (13) of the hand power tool, embodied as a base (16) to stand on, engages the receptacle (30) in form-locking and/or force-locking fashion.

10. The device as defined by claim 9, wherein the device has at least one recess (37) for receiving a tool insert (20).

11. The hand power tool as defined by claim 1, wherein the base has a substantially flat underside.

12. The hand power tool as defined by claim 1, wherein the handgrip has a contour and the at least one rechargeable battery is a single polymer cell adapted to the contour of the handgrip.

13. The hand power tool as defined by claim 3, wherein the mean for electronic torque limitation include a printed circuit board.
